(19) United States
(12) Patent Application Publication
(10) Pub. No.: US 2025/0114649 A1
(43) Pub. Date: Apr. 10, 2025

(54) A CBRN COAT

(71) Applicant: SEYNTEX, Aalter (BE)

(72) Inventors: Filip GHEKIERE, Waregem (BE); Lieven SMISSAERT, Lievegem (BE)

(21) Appl. No.: 18/729,500

(22) PCT Filed: Dec. 16, 2022
(86) PCT No.: PCT/EP2022/086401

§ 371 Date: Jul. 16, 2024

(30) Foreign Application Priority Data
Jan. 17, 2022 (EP) 22075002.0

(51) Int. Cl. A62B 17/00; A41D 13/00; A42B 1/04; A44B 19/00; A62B 17/04

(52) U.S. Cl. CPC A62B 17/006; A41D 13/0002; A42B 1/04; A44B 19/00; A62B 17/04

(57) ABSTRACT

A CBRN coat is provided with two sleeves, at least one chest section and a hood. The coat has a face-cover connected to the at least one chest section with an opening for receiving a gasmask extending partially through the opening. The opening has an uninterrupted circumference. The coat has a zipper connecting the hood to the face-cover, thereby forming a head covering which encapsulates the head of the wearer when wearing said coat.

### FIELD OF THE INVENTION

The present invention generally relates to CBRN suits, CBRN coats and CBRN suits comprising such CBRN coat.

### BACKGROUND OF THE INVENTION

A CBRN (chemical, biological, radiological, nuclear) suit, formerly referred to as NBC (nuclear, biological, chemical) suit, and also called chemsuit, chem suit or chemical suit, is a type of military personal protective equipment. CBRN suits are designed to provide protection against direct contact with and contamination by radioactive, biological or chemical substances.

A first type of a CBRN suit comprises an overall, more precise a coverall. The body of the soldier is covered completely by one piece of clothing. Putting on these overall suits is not convenient for the soldiers in the battlefield. A large opening on the upper side of the suit is to be provided to allow the soldier, wearing already his or her battledress, to get into his or her CBRN overall suit from the topside of the suit downwards. Putting on the overall requires time, which is scarce during combat. This large opening obviously is to be closed tightly and is to stay properly closed once the overall is worn. To stay close tightly, the opening needs to be subjected to as little forces or folding actions as possible. As the closure is long, this may not be the case along the whole length of the closure during combat. The suit is also to be carried along as one piece in a packaging, which is large and cumbersome.

To allow putting on of the overall suits more easily, the overall suits are usually sized quite large, thereby being less comfortable to wear and work in during combat. These types of CBRN overall suits are less adapted to comply with the presently used three-phase alarm protocols. Similarly, a two-piece suit has been applied, where a pair of pants and a pullover was provided. The pullover was provided with a complete head covering which encapsulates the head and face of the wearer, and having an opening at the face-side of the head covering to accommodate the gasmask being worn by the user. Also these suits are usually quite large, uncomfortable to put on seen the absence of any possibility to enlarge the pullover during pulling on the pullover, are less comfortable to wear and work in during combat and are less adapted to comply with the presently used three-phase alarm protocols.

Therefore a second type of CBRN suit may be used. These CBRN suits typically are two-piece or multi-piece suits, comprising at least a CBRN coat or jacket and a CBRN pair of pants. A pair of pants is more easily pulled over the battledress as compared to an overall. A coat can either be easily slipped on over the head of the wearer, or put on like a jacket, by first putting the arms in the sleeves and then closing the closure of the coat or jacket in front of the coat or jacket. This action requires less time and provides a suit fitting better the body's physique. Further, these kinds of CBRN suits are easier in use and are adapted to comply with the presently used three-phase alarm protocols.

At present, such alarm protocol for wearing CBRN protective clothing has three phases. In a first alarm phase, the soldiers are instructed to get themselves ready for a possible attack. The soldiers are to put on the pants of their CBRN suit. The coat, usually a jacket, and gasmask remain in its packaging. In alarm phase two, the soldier is to prepare for the actual attack. The soldier puts on his or her coat or jacket, but can leave the coat or jacket open, which is more comfortable for the soldier during this second phase. The gasmask remains in the packaging. At the proclamation of phase three, the actual eminent attack, the soldier puts on his or her gasmask, and closes the CBRN jacket. As of this very moment, there is an important threat of getting contaminated with life-threatening chemical, biological or radioactive material. The CBRN suit is closed and is to be kept closed. Also for the boots, hand gloves and alike, instructions are given in each phase. So this protocol requires a multi-piece suit, comprising pants and a coat or jacket, to be able to follow the instructions.

A multi-piece CBRN suit is shown in KR101047944 or the flyer “CBRN” from Seyntex NV (BE). See also the website of Seyntex NV (BE); see http://www.seyntex.com/en/our-products/cbrn-protection-0. Such CBRN coats or jackets have a disadvantage. There is a point, usually near the chin or cheek of the soldier, where the top edge of the zipper, closing the coat, the seal of the hood and the outer surface of the gasmask meet. This is a critical point of the CBRN coat or jacket for showing leakages. The hood and the surface of the gasmask need to be sealed one to the other properly. For this some elasticity is provided at the outer ends of the hood where this outer end meets the surface of the gasmask. The tension applied by the elastic outer end of the hood is to be properly and evenly distributed. The presence of the outer end of the zipper disturbs this tension distribution. To be sure this point is properly closed, the hood and the gasmask need to be properly designed and elaborated, even for each size of the CBRN coat or jacket, which is cumbersome. Even more, when worn, a buddy soldier is to check this point of the CBRN coat or jacket. The soldier wearing the CBRN coat or jacket cannot visually inspect him- or herself the condition of this critical point. This is burdensome, may be a source of time wasted and is a high risk for the soldier wearing the CBRN suit. A similar critical point may apply to the CBRN overalls. The top edge of the zipper closing the opening in the overall is a critical point of the CBRN overall for showing leakages and should be taken care of properly to have the soldier to have a complete CBRN protection.

In WO2017/013418 head covering is described being suitable for use as part of a protective clothing. The head covering, being a separate part of the clothing, is to be pulled over the whole head of the user, including the face part of the head, and is thereafter connected to the vest of the protective clothing by means of a zipper, which follows a path around the neck of the user. Mounting the separate head covering to the vest requires manual actions behind the head at the level of the neck by the user. This requires great flexibility of the user's arms and is experienced as difficult and time consuming. The fact the head covering is a separate piece of clothing requires several pieces of equipment to be taken care of, and may cause loss of the head covering.

In WO2021/047789 a head covering is described which includes a face covering part and a hood. The head covering is part of a protective suit. At the front side of the head covering, along the neck part of the head covering, a zipper is provided to partially open the head covering and allow the user's head to slip into the head covering by a movement of the head upwards into the head covering. Such protective suit requires flexibility of the user's neck region, while the head covering, with opened zipper along the neck part, may hinder the user when the protective suit is worn without the head covering being fit onto the head.

### SUMMARY OF THE INVENTION

According to a first aspect of the invention, a CBRN coat is provided. The CBRN coat comprises two sleeves, at least one chest section and a hood. The coat comprises a face-cover connected to the at least one chest section, the face-cover comprising an opening for receiving a gasmask extending partially through this opening. The opening has an uninterrupted circumference, and the coat comprises a zipper connecting the hood to the face-cover, thereby forming a head covering which encapsulates the head of the wearer when wearing the coat. Hence the edge of the hood and the edge of the face-cover are connectable by means of a zipper along the length of the edges. As is clear, the hood leaves the face of a user of the CBRN coat uncovered.

A coat is a sleeved apparel or garment adapted to cover at least the upper side of a wearer, i.e. the head, the arms, the thorax or chest, the abdomen of the body, and the back of the body and is free of legs. The CBRN coat is part of a multi-piece CBRN suit.

In the context of this invention, a hood is an integral part of the coat, which part covers the backside of the neck and the part of the head of the user at least up to the crown of the head, possibly up to the forehead of the user. The hood leaves the face uncovered. The hood is adapted to be removed by moving the hood back from the head away to the neck. In the context of this invention, a face-cover is an integral part of the coat, which part covers the face of the user, and optionally also at least a part of the front side of the neck of the user, like the throat. Integral parts means that the two parts are permanently connected (like sewn or welded on to the other) or forming or being made from one piece of cloth.

Hence the CBRN coat according to the first aspect of the invention, may comprise two sleeves, at least one chest section and a hood, said hood being an integral part of the coat and covering the backside of the neck and the part of the head of the user at least up to the crown of the head. The coat comprises a face-cover connected to the at least one chest section, said face-cover being an integral part of the coat, covering the face of the user, and optionally also at least a part of the front side of the neck of the user. The face-cover comprises an opening for receiving a gasmask extending partially through this opening. The opening has an uninterrupted circumference. The coat comprises a zipper connecting the hood to the face-cover, thereby forming a head covering which encapsulates the head of the wearer when wearing the coat. Hence the edge of the hood and the edge of the face-cover are connectable by means of a zipper along the length of the edges.

The zipper is adapted to connect the hood to the face-cover along the whole length of the edge of the face-cover and the edge of the hood. This in order to provide a closed connection between these two sections of the coat.

These coats have the advantage that the zipper and the gasmask's outer surface are not to contact each other near or at the end, i.e. the top edge, of the zipper. The circumference or edge of the opening in the face-cover can neatly and uninterruptedly fit to the outer surface of the gasmask. As such, a critical point of the CBRN coat can be avoided, while the CBRN coat can be used to comply with the three phase alarm protocols.

According to some embodiments, the zipper's bottom edge may be positioned in one of the at least one chest section at one of the left- and righthand side of the coat, said zipper follows a closing path which closing path passes along the edge of the hood over the head of the user towards the other of the left- and righthand side of the coat.

According to some embodiments, the zipper may follow a closing path which closing path may pass along one jaw and cheek of the user, along the forehead or the crown of the user, at least up to the second cheek of the user, and possible further along the second cheek of the user up to the second jaw of the user, and even possibly further along the second jaw of the user downwards to the chest section or sections.

Preferably the ear or ears of the user of the CBRN coat, are covered by the hood. The closing path of the zipper may be positioned between zygion at the cheek and tragus of the ear.

According to some embodiments, the zipper's top edge may be positioned in one of the at least one chest section or sections.

Preferably the zipper's top edge is positioned or lies in one of the at least one chest section, between the foremost connection point of the hood to this one of the at least one chest section, and the hem of the coat. The top edge of a zipper is the point or position of the slider along the zipper when the zipper is fully closed. It equals the position of the top stops of the zipper. The bottom edge of a zipper is the point or position of the slider along the zipper when the zipper is fully opened. It equals the position of the bottom stops of the zipper or the box and pin of the zipper. The closing path is the path the chain and the two tapes of the zipper follow when being closed. It equals the path the slider of the zipper follows when opening and closing the zipper. The hem of the coat is the lowermost border of the coat.

The coat may have a back section, the zipper may end, and its top edge may be positioned in the chest section, between the hem of the coat and the transition, e.g. the transition line or seam, of the chest section and the back section. When the back section and the chest section are distinguished parts, connected to each other at the shoulder of the coat by means of a seam, the zipper may end and its top edge may be positioned in the chest section, between this shoulder seam and the hem of the coat.

Preferably the zipper ends, and its top edge may be positioned, at a position in the chest section of the coat, between the height of one of the clavicles of the person wearing the coat and the hem of the coat. More preferred, the zipper ends, and its top edge may be positioned between a position in the chest section of the coat between the height of one of the pectoral muscles of the person wearing the coat and the hem of the coat. Most preferably the zipper extends at least from one of the left-hand and right-hand pectoral muscle of the wearer, around the head, to or even past the clavicle and optionally at least up to the other of the left-hand and right-hand pectoral muscle of the wearer.

In the context of this invention, when reference is made to “left” or “right”, and unless otherwise explained, left and right is to be understood as seen from the perspective of the wearer of the coat or suit.

The provision of the end of the zipper at or beyond the shoulder seam, e.g. at or beyond the clavicle, more preferred at or beyond the pectoral muscle of the soldier, provides the possibility to the soldier wearing the CBRN coat to visually inspect the closure of the end of the zipper him- or herself. No buddy soldier is strictly necessary for this inspection.

Further, the face-cover may be carried in alarm phase two in an opened way hanging in front of the chest of the wearer. Possibly a connection system is provided to releasably connect the outer surface of the face-cover to one, e.g. the at least first chest section.

According to some embodiments, the coat may comprise a first and a second chest section, e.g. a left-hand and a right-hand chest section, connectable to each other by means of said zipper.

The coat may comprise one belly section or belly sections to which the two chest sections are connected. As such the coat forms an anorak-like or parka-like garment. Possibly the belly section and the one or more chest sections may form an integral part of the same piece of textile fabric.

According to some embodiments, the coat may comprise a first and a second belly section, e.g. a left-hand and a right-hand belly section, connectable to each other by means of said zipper.

The left-hand chest section, respectively the right-hand chest section may extend in a left-hand, respectively a right-hand belly section, which belly sections may be connected and disconnected to each other by means of the same zipper. The belly sections may provide the hem of the coat. As such, a jacket is provided, which jacket may be completely opened.

The coat further comprises a back section which is connected to the hood. All these sections of the coat may be individual sections being sewn or otherwise permanently connected one to the other. Alternatively some or all sections may form an integral part of the same piece of textile fabric, being preferably a layered textile material.

The coat further comprises two sleeves: a left-hand sleeve and a right-hand sleeve. The coat is a so-called sleeved coat.

One of the advantages of the coat according to the invention is that the sealing between the coat and the gasmask is no longer compromised by the presence of a zipper top edge or end at or near the seal. The mere presence of this zipper end or top edge at this position provides the utmost weak point as far as protection against infiltrating gas or liquid is concerned. The coats of the invention avoid the presence of this weak point.

According to some embodiments, the zipper may follow a closing path from the one of the at least one chest section obliquely towards the first of the left- or right-hand shoulder of the coat, up to the foremost connection point of the hood to this chest-section.

This zipper may follow a closing path from the hem of the coat, in this case a jacket, upwards to the chest sections of the coat.

According to some embodiments, the zipper may follow a closing path from the foremost connection point of the hood to the chest-section, around the edge of the hood towards the other of the left-hand or right-hand shoulder of the coat. The face-cover has a strip of fabric, e.g. a piece of layered textile material, between the opening and the edge of the face-cover where the zipper is present.

Possibly the zipper extends downwards from the other of the left- or right-hand shoulder to or into the opposite chest side of the coat.

The face-cover may hang in front of the coat when the zipper is not closed beyond the foremost connection point of the hood to the chest-section. The face-cover may be rolled up and/or provisionally connected to the front of the coat.

As such, the coat according to the invention can be worn by the soldiers in the second and third phase of a CBRN alarm. When a CBRN alarm is given, in a first phase of the alarm, the coat according to the invention, may remain unworn. The pants of the CBRN protective suit are put on. In a second alarm phase, the coat is pulled or put on, but the zipper may stay unzipped, the hood and the face-cover remaining uninstalled, and the gasmask is not worn. This gives the soldier more comfort during this second phase. In the third phase of an alarm, the gasmask is put on and the zipper is simply closed. The opening in the face-cover appears in front of the gasmask and the soldier can easily extend the gasmask through the opening. As the seal is formed by the edge of the opening and a protruding rib on the outer surface of the gasmask, and as the edge of the opening is uninterrupted, the seal may perfectly fit and close without undue burden of the soldier. The zipper can be easily closed completely by the soldier him- or herself. As such, there is no absolute necessity to have the seal and the closing of the zipper being checked by a buddy soldier.

According to some embodiments, the zipper may be present in the front half of the head covering provided by the face-cover and the hood.

The zipper preferably is provided along the forehead of the wearer when wearing the coat in closed state. This position and condition of the zipper can easily be checked by the soldier wearing the coat, as it only needs a mirroring surface to check the status of the zipper. This is not the case when the zipper would be more to the top- or backside of the head, like a zipper crossing the crown or the back of the head.

Preferably there is a strip of fabric present between the edge of the opening in the face-cover and the one part of the zipper connected to the edge of the face-cover, which strip of fabric has a width of at least 1 cm, such as in the range of 1 to 20 cm. This causes the zipper still to be present on the face-side of the head of the wearer, i.e. along the forehead of the wearer. This while the stress which acts upon the zipper when closing and while being closed, and during battle because of the movement of the soldier, is not influencing the performance of the seal between the edge of the opening and the gasmask.

In the context of this invention, when reference is made to a range, and unless otherwise explained, the range is to be understood as including the end points of the range.

According to some embodiments, the zipper may be covered at its outer side by at least a first flap.

According to some embodiments, the zipper may be covered at its outer side by at least a second flap extending partially or completely over the first flap.

The first and optionally the second flap may follow the path of the zipper from the start or bottom edge of the zipper unto the outer end or top edge of the zipper. In case of two flaps, each of the flaps may run along the chain of the zipper, at one of the left and right side of the zipper.

Possibly the one flap, or in case of more than one flap, the outermost flap, is oriented with its opening towards the front side of the coat. This facilitates to a large extent the possibility to properly close the zipper by the soldier without any help.

Possibly the outermost flap is oriented with its opening towards the rear side of the coat. This facilitates to a large extent the possibility to have protection against splashes and/or droplets of chemical or bacteriological weapons, the splashes and/or droplets flying towards the soldiers during combat.

Optionally the flap or flaps may be provided with a corded seam or piping (FR: passepoil), and/or may comprise one or more resilient means, like a spring such as a torsion spring, e.g. a bistable spring, adapted to fold over and hold the flap in front of the zipper.

Optionally the zipper has at its outer surface, either on the inner side, the outer side or both inner and outer side, a water repellent coating. As an example, the zipper may be coated with a polyfluoroalkyl substance (PFAS) coating, like a perfluorooctyl substance coating, e.g. Teflon®.

Such coating may make the zipper more liquid tight.

According to some embodiments, the material of the outer flap may be identical to the textile material from which the hood of the suit is made.

In order not to have different properties, like IR reflectance, between the hood and the covering of the zipper, the material of the outer flap is preferably identical to the textile material from which the hood of the suit is made. As such, the flap or flaps may hide the presence of this zipper, hence the soldier wearing the CNRB coat, in the battlefield. Possibly, an uncovered zipper may be noticed through its possibly deviating IR reflectance, such as a deviation in the wavelength range of 400 to 1200 nm, or its geometrical shape.

These provisions to provide and the properties of the flap or flaps to cover a zipper at the outer side of the zipper, may be provided to any zipper present in any CBRN suit.

The CBRN coat is preferably made of a layered textile material, following military requirements, like the NATO requirements (AEP38 and AEP 85 low burden). With a layered textile material is meant a combination of layers of textile material, the layers being superposed one to the other. The layers of textile material may be partially or completely laminated one to the other. The outer layer preferably is a water- and oil repellent textile layer, typically to provide shelter to chemical warfare agents in liquid form, and being provided with appropriate IR reflectance. The outer layer's outer surface is usually provided with a camouflage print, adapted to the environment in which the suit is to be used, like North German lowlands, arid fields, snow-covered fields, etc. The outer layer may be flame retardant. This outer layer may e.g. be provided from cotton, a polyester-cotton mixture or a polyamide-cotton mixture. This outer layer may have a surface weight in the range of 130 g/m² tot 400 g/m², such as in the range of 150 g/m² to 260 g/m², e.g. in the range of 170 g/m² to 230 g/m².

The layered textile material may have an air permeability less than 750 l/m²s at 100 Pa, e.g. less than 650 l/m²s at 100 Pa, less than 500 l/m²s at 100 Pa, less than 400 I/m²s at 100 Pa, e.g. in the range of 70 to 200 l/m²s, even in the range of 70 to 100 l/m²s. This air permeability may be important to meet the criteria for protection against gaseous warfare agents, e.g. AEP 38 or AEP 85.

Under the outer layer, one or more intermediate layers may be provided. As an example, an intermediate layer for providing shielding against aerosol warfare agents, and/or an intermediate layer comprising activated carbon may be provided. An intermediate layer comprising activated carbon may neutralize warfare agents having passed though the preceding layers, and may be a layer comprising activated carbon power, activated carbon spheres or even activated carbon fibers and/or filaments. Preferably, a minimum of 50 g/m² of activated carbon is provided, optionally a minimum of 60 g/m² or 70 g/m², even a minimum of 100 g/m². Underneath this or these intermediate layers, a liner may be provided to improve the comfort to the wearer.

As a mere example, a layered textile material comprising an outer layer with a surface weight in the range of 170 to 220 g/m², e.g. ca 175 g/m², the outer layer being provided with a layer of glue, e.g. about 40 g/m² glue, with an intermediate layer comprising or even consisting of active carbon is provided, e.g. a layer comprising an amount of active carbon in the range of 80 to 120 g/m².

All parts of the CBRN suit are preferably made from this layered textile material, including the hood, the chest section or sections covering the thorax or chest, the belly section or sections covering the abdomen of the body, the back section covering the back of the body, and the optional flap or flaps covering the zipper.

The CBRN coat according to the invention is preferably a so-called “permeable CBRN coat”, where an appropriate evacuation of sweat and/or heat may be achieved.

According to some embodiments, the zipper may be provided at its inner side with a covering strip of material, the covering strip is a layered strip comprising a hydrophobic and/or oleophobic outer layer contacting the inner side of the zipper.

The covering strip of material covers the complete zipper from at least the left side of the left tape of the zipper, along the chain of the zipper, up to or even beyond the right side of the right tape of the zipper.

The outer layer may be a hydrophobic and/or oleophobic film or tape, even a water impermeable film or tape. Alternatively the outer layer of the strip may be a hydrophobic and/or oleophobic, even a water impermeable textile layer, which may be identical to the outer layer of the layered textile material from which the suit is made.

According to some embodiments, the zipper may be provided at its inner side with a covering strip of material, the covering strip is a layered strip comprising an intermediate layer comprising activated carbon, which layer is free of contact with the zipper.

According to some embodiments, the zipper may be provided at its inner side with a covering strip of material, the covering strip is a layered strip comprising a hydrophobic and/or oleophobic outer layer contacting the inner side of the zipper, said layered strip further comprising an intermediate layer comprising activated carbon, which intermediate layer is provided at the side of the hydrophobic and/or oleophobic outer layer, which side is pointing away from the zipper.

According to some embodiments, the suit may be made of a layered textile material, the zipper is provided at its inner side with a covering strip of material, which covering strip of material is identical to the layered textile material from which the suit is made.

These provisions to provide flap or flaps to cover a zipper at the inner side of the zipper, may be provided to any zipper present in any CBRN suit.

According to some embodiments, the circumference of the opening in the face-cover may be provided with elastic properties.

The circumference or edge of the opening may have a seam in which an elastic band or strip is integrated. Optionally the fabric of the face-cover itself may have elastic properties. Additionally or alternatively, the circumference or edge of the opening may be provided with a seal, e.g. a rubber seal, which fits tightly to the outer surface of the gasmask and provides the appropriate closure between circumference or edge of the opening and gasmask. Alternatively or additionally, the circumference or edge of the opening may be provided with a, preferably relatively stiff, first piece of a closure system, which mates airtightly with a second piece of this closure system, being present on the external rim of a device to cover the opening, e.g. a gasmask, or alike.

According to a second aspect of the invention, a CBRN garment is provided, the garment comprising two sleeves, at least one chest section and a hood. The garment comprises a face-cover connected to the at least one chest section. The face-cover comprises an opening for receiving a gasmask extending partially through said opening and the opening having an uninterrupted circumference. The garment comprises a zipper connecting the hood to the face-cover, thereby forming a head covering which encapsulates the head of the wearer when wearing said garment. The zipper's top edge is positioned in one of the at least one chest section. Preferably the zipper's top edge and the zipper's bottom edge is positioned in one of the at least one chest section. The top edge and the bottom edge may be positioned in one and the same chest section, but more preferred, the top edge may be positioned in one chest section, the bottom edge being positioned in another chest section. These two chest sections may be the left-hand chest section and the right-hand chest section of a coat, like a jacket, or an overall. The bottom edge may be provided at the bottom of the closure between the two chest sections and/or the zipper may provide the connection between the two chest sections.

The garment may be an overall, a coverall, a coat, a jacket, an anorak-like or parka-like garment or any other garment that covers the head, thorax or chest and abdomen of the wearer.

The garment may have a back section, the zipper may end, and its top edge may be positioned in the chest section, downwards from the transition line of the chest section and the back section. When the back section and the chest section are distinguished parts, connected to each other at the shoulder of the garment by means of a seam, the zipper may end and its top edge may be positioned in the chest section, downwards from the shoulder seam.

Preferably the zipper ends, and its top edge may be positioned at a position in the chest section of the garment, between the height of one of the clavicles of the person wearing the garment and the waistline of the garment. More preferred, the zipper ends, and its top edge may be positioned between a position in the chest section of the garment between the height of one of the pectoral muscle of the person wearing the garment and the waistline of the garment. Most preferably the zipper extends at least from one of the left-hand and right-hand pectoral muscles of the wearer, around the head, at least up to the other of the left-hand and right-hand pectoral muscle of the wearer.

The provision of the top edge or end of the zipper at or beyond shoulder seam, e.g. at or beyond the clavicle, more preferred at or beyond the pectoral muscle of the soldier, provides the possibility to the soldier wearing the CBRN coat to inspect him- or herself the closure of the top edge or end of the zipper visually. No buddy soldier is strictly necessary for this inspection.

The features of the CBRN coat according to the first aspect of the invention may be combined with these CBRN suits according to the second aspect of the invention.

According to a third aspect of the invention, a CBRN suit comprising a CBRN coat according to the first aspect of the present invention, is provided.

### BRIEF DESCRIPTION OF THE DRAWINGS

FIG. 1 illustrates schematically a right-side view of a coat according to the invention.

FIG. 2 illustrates schematically a left-side view of this coat according to the invention. and

FIGS. 3, 4 and 5 illustrates schematically a possible closing of a zipper being covered with flaps on inner and outer side of the coats according to the invention.

The same reference signs refer to the same or a similar feature in the different figures.

### DETAILED DESCRIPTION OF EMBODIMENT(S)

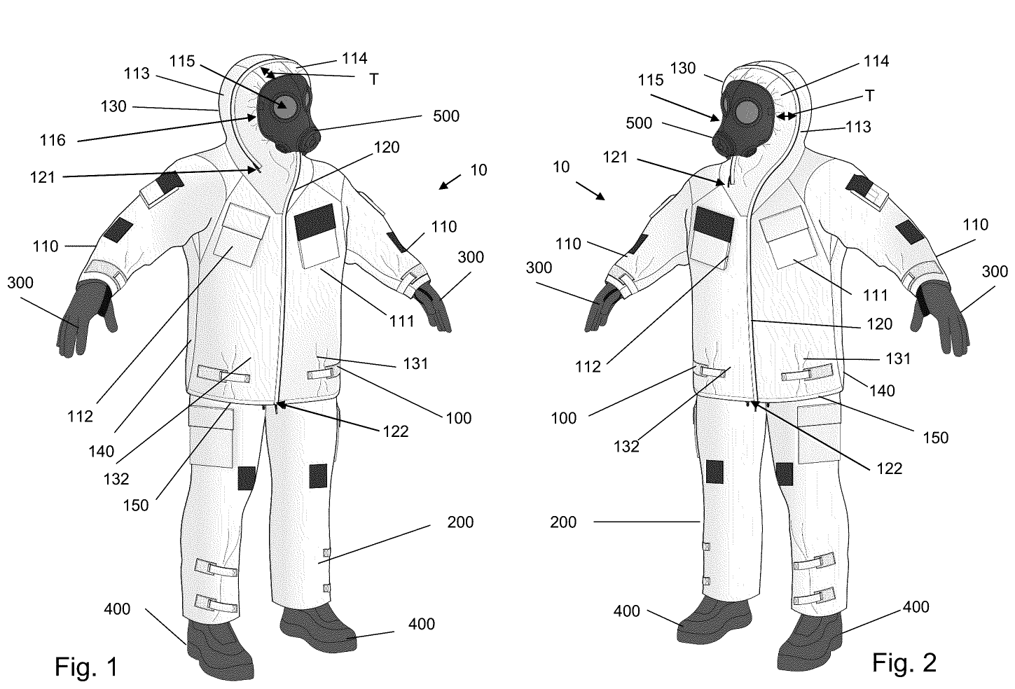

In FIG. 1 a right-side view of a CBRN coat 100 according to the invention is provided, the coat 100 being a jacket. The CBRN coat 100 is part of a CBRN suit 10, which suit 10 further comprises a pair of CBRN pants 200, A pair of CBRN gloves 300, a pair of CBRN boots 400 and a gasmask 500.

The CBRN coat 100 comprises two sleeves 110, a left chest section 111 and a right chest section 112, a hood 113, a back section 140 and a hem 150. The coat comprises a face-cover 114 connected to the right-hand chest section 112. The face-cover 114 comprising an opening 115 for receiving the gasmask 500 extending partially through this opening 115. The opening 115 has an uninterrupted circumference 116. The coat 100 comprises a zipper 120 connecting the hood 113 to the face-cover 114, thereby forming a head covering 130 which encapsulates the head of the wearer when wearing the coat 100. Hence the edge of the hood 113 and the edge of the face-cover 114 are connectable by means of the zipper 120 along the length of the edges.

The coat 100 further comprises a left-hand belly section 131, connected to the left-hand chest section 111, and right-hand belly section 132, connected to the right-hand chest section 112. The left-hand chest section 111, respectively the right-hand chest section 112 extends in a left-hand, respectively a right-hand belly section 131 and 132. These chest sections 111 and 112 and belly sections 131 and 132 are connectable and disconnectable to each other by means of the zipper120.

The bottom edge 122 of the zipper 120 is positioned at the hem 150 of the coat 100. The top edge 121 of the zipper 120 is positioned or lies in the right-hand chest section 112, between the height of the clavicle of the person wearing the coat and the hem of the coat. Hence as shown in the embodiment in FIG. 1, the zipper 120 extends from the hem 150 of the coat 100, between the belly sections 131 and 132, between the chest sections 111 and 112, from left-hand pectoral muscle of the wearer, around the head over the forehead between the edges of the face-cover 114 and the hood 113, and back downwards towards the hem 150, past the right-hand clavicle of the wearer about up to the pectoral muscle. The zipper 120 does not pass or end near the opening 115 on the face-cover 114, therefore does not cause a critical closing point at the circumference of the opening 115. The opening circumference 116 remains uninterrupted. The provision of this top edge 121 of the zipper 120 in the field of view of the soldier wearing the coat, including the gasmask, allows a visual inspection of the critical point of the closing by the soldier him- or herself.

Optionally the fabric of the face-cover has elastic properties or an elastic band or strip is integrated along the opening circumference 116. The circumference 116 of the opening 115 may be provided with, optionally coupled to, a rubber seal, like a butyl-based rubber seal, which fits tightly to the outer surface of the gasmask 500 and provides the appropriate closure between circumference 116 of the opening 115 and gasmask 500.

There is a strip of fabric present between the edge of the opening 115 in the face-cover 114 and the one part of the zipper 120 connected to the edge of the face-cover 114, which strip of fabric has a width T in the range of 10 to 20 cm.

As shown in FIG. 1, the coat 100, as well as the pair of pants 200, may be provided with pockets, straps, closures, and alike as known in the art.

The CBRN coat 100 is made of a layered textile material, following military requirements, like the NATO requirements (AEP38 and AEP 85 low burden). The outer layer is a cotton-polyester textile woven fabric with a surface weight of about 150 to 200 g/m², e.g. about 175 g/m², which outer textile layer is made water- and oil repellent, and being provided with appropriate IR reflectance pattern, such as a camouflage print.

Under the outer layer, an intermediate layer for providing shielding against aerosol warfare agent is provided. Further, an intermediate layer comprising activated carbon is provided Preferably, a minimum of 50 g/m² of activated carbon is provided. Optionally a minimum of 60 g/m² or 70 g/m^{2,} even a minimum of 100 g/m² of activated carbon is provided. Underneath these intermediate layers, a liner is provided to improve the comfort to the wearer.

The layered textile material may have an air permeability less than 250 I/m²s at 100 Pa, e.g. in the range of 70 to 200 l/m²s, even in the range of 70 to 100 I/m²s.

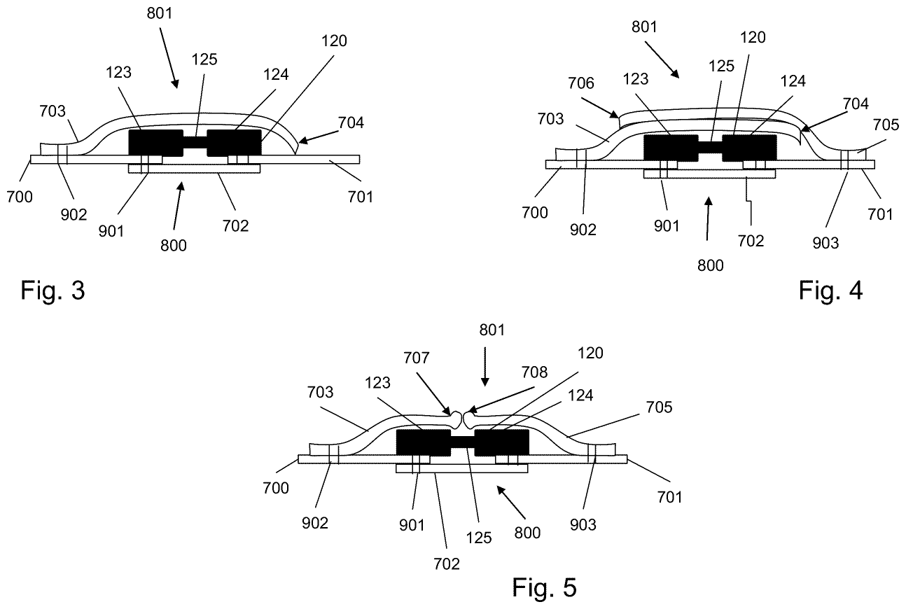

Turning to FIGS. 3 to 5, possible details of the closing between the face-cover 114 and the hood 113 are provided. In FIG. 3, one edge 700 of layered textile material, being part of one of the face-cover 114 and the hood 113, is coupled to the first tape 123 of the tapes 123 and 124 of the zipper 120. One edge 701 of layered textile material, being part of the other of the face-cover 114 and the hood 113, is coupled to the second tape 124 of the tapes 123 and 124 of the zipper 120. Between the tapes 123 and 124, the teeth 125 of the zipper are present. At the inner side 800 of the closing between the face-cover 114 and the hood 113, a first strip 702 of layered textile material is provided, extending at least over the width of the zipper 120, and hence covering the tapes 123 and 124. This strip 702 is connected to the edge 700 of the layered textile material, e.g. by a seam 901. This strip 702 at the inner side of the closing prevents any material which might have passed the zipper from the outside of the coat inwards, to be captured and prevented to pass to the body of the soldier wearing the CBRN coat.

At the outer side 801 of the closing between the face-cover 114 and the hood 113, a second strip 703 of layered textile material is provided, extending at least over the width of the zipper 120 and the width of the first strip 702. The second strip is dimensioned such that it covers the tapes 123 and 124. This second strip 703 is connected to the edge 700 of the layered textile material, e.g. by a seam 902. The second strip 703 is dimensioned such that the non-connected side 704 lies at least against the other edge 701, to which it is not connected.

An alternative closing is shown in FIG. 4. In FIG. 4, one edge 700 of layered textile material, being part of one of the face-cover 114 and the hood 113, is coupled to the first tape 123 of the tapes 123 and 124 of the zipper 120. One edge 701 of layered textile material, being part of the other of the face-cover 114 and the hood 113, is coupled to the second tape 124 of the tapes 123 and 124 of the zipper 120. Between the tapes 123 and 124, the teeth 125 of the zipper are present. At the inner side 800 of the closing between the face-cover 114 and the hood 113, a first strip 702 of layered textile material is provided, extending at least over the width of the zipper 120, and hence covering the tapes 123 and 124. This strip 702 is connected to the edge 700 of the layered textile material, e.g. by a seam 901. At the outer side 801 of the closing between the face-cover 114 and the hood 113, a second strip 703 of layered textile material is provided, extending at least over the width of the zipper 120 and the width of the first strip 702. The second strip 703 is dimensioned such is covers the tapes 123 and 124. This second strip 703 is connected to the edge 700 of the layered textile material, e.g. by a seam 902. The second strip 703 is dimensioned such that the non-connected side 704 extends beyond the second tape 124. Further, also at the outer side 801 of the closing between the face-cover 114 and the hood 113, a third strip 705 of layered textile material is provided, extending at least over the width of the zipper 120 and the width of the first strip 702. The third strip 705 is dimensioned such is covers the tapes 123 and 124. This third strip 705 is connected to the edge 701 of the layered textile material, e.g. by a seam 903. The third strip 705 is dimensioned such that the non-connected side 706 extends beyond the first tape 123. Such closing provides more certainty that the zipper in closed condition, is always covered by at least one strip of layered textile material.

Still another alternative closing is shown in FIG. 5. In FIG. 5, one edge 700 of layered textile material, being part of one of the face-cover 114 and the hood 113, is coupled to the first tape 123 of the tapes 123 and 124 of the zipper 120. One edge 701 of layered textile material, being part of the other of the face-cover 114 and the hood 113, is coupled to the second tape 124 of the tapes 123 and 124 of the zipper 120. Between the tapes 123 and 124, the teeth 125 of the zipper are present. At the inner side 800 of the closing between the face-cover 114 and the hood 113, a first strip 702 of layered textile material is provided, extending at least over the width of the zipper 120, and hence covering the tapes 123 and 124. This strip 702 is connected to one of the edges 700 and 701 of the layered textile material, e.g. by a seam 901. At the outer side 801 of the closing between the face-cover 114 and the hood 113, a second strip 703 of layered textile material is provided, extending at least over half the width of the zipper 120, thereby covering the first tape 123 and half of the width of the teeth 125. The seam 707 along the second strip 703 is provided with a cord. This second strip 703 is connected to the edge 700 of the layered textile material, e.g. by a seam 902. Further, also at the outer side 801 of the closing between the face-cover 114 and the hood 113, a third strip 705 of layered textile material is provided, extending at least over half the width of the zipper 120, thereby covering the second tape 124 and half of the width of the teeth 125. The seam 708 along the third strip 705 is provided with a cord. This third strip 705 is connected to the edge 701 of the layered textile material, e.g. by a seam 903. The two seams 707 and 708 along the second strip 703 and third strip 705 together form a corded seam or piping. The piping or corded seam (French: passepoil) comprising the two seams 707 and 708 has the tendency to be self-closing, due to the presence of the cords.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this document that the words “comprising” or “comprise” do not exclude other elements or steps, that the words “a” or “an” do not exclude a plurality, and that a single element may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A CBRN coat comprising:
two sleeves,
at least one chest section, and
a hood,
wherein wherein said coat comprises a face-cover connected to the at least one chest section, said face-cover comprising an opening for receiving a gasmask extending partially through said opening, the opening having an uninterrupted circumference, said coat comprises a zipper connecting the hood to the face-cover, thereby forming a head covering which encapsulates the head of the wearer when wearing said coat.

2. The CBRN coat according to claim 1, wherein said zipper's bottom edge is positioned in one of the at least one chest section at one of the left- and righthand side of the coat, said zipper follows a closing path which closing path passes along the edge of the hood over the head of the user towards the other of the left- and righthand side of the coat.

3. The CBRN coat according to claim 1, wherein said zipper's top edge is positioned in one of the at least one chest section.

4. The CBRN coat according to claim 1, said coat comprises a left-hand and a right-hand chest section connectable to each other by means of said zipper.

5. The CBRN coat according to claim 4, said coat comprises a left-hand and a right-hand belly section connectable to each other by means of said zipper.

6. The CBRN coat according to claim 1, wherein the zipper follows a closing path from the one of the at least one chest section obliquely towards the first of the left- or right-hand shoulder of the coat up to the foremost connection point of the hood to this chest-section.

7. The CBRN coat according to claim 1, wherein the zipper follows a closing path from the foremost connection point of the hood to the chest-section, around the edge of the hood towards the other of the left-hand or right-hand shoulder of the coat.

8. The CBRN coat according to claim 1, wherein said zipper is present in the front half of the head covering provided by the face-cover and the hood.

9. The CBRN coat according to claim 1, wherein said zipper is covered at its outer side by at least a first flap.

10. The CBRN coat according to claim 9, wherein said zipper is covered at its outer side by at least a second flap extending partially or completely over the first flap.

11. The CBRN coat according to claim 9, wherein the material of the outer flap is identical to the textile material from which the hood of the suit is made.

12. The CBRN coat according to claim 1, wherein the zipper is provided at its inner side with a covering strip of material, the covering strip is a layered strip comprising a hydrophobic and/or oleophobic outer layer contacting the inner side of the zipper.

13. The CBRN coat according to claim 1, wherein the zipper is provided at its inner side with a covering strip of material, the covering strip is a layered strip comprising an intermediate layer comprising activated carbon, which layer is free of contact with the zipper.

14. The CBRN coat according to claim 1, wherein the suit is made of a layered textile material, the zipper is provided at its inner side with a covering strip of material, which covering strip of material is identical to the textile material from which the suit is made.

15. The CBRN coat according to claim 1, wherein the circumference of the opening in the face-cover is provided with elastic properties.

16. A CBRN suit comprising the CBRN coat according to claim 1.
